(19) United States
(12) Patent Application Publication
(10) Pub. No.: US 2017/0052761 A1
(43) Pub. Date: Feb. 23, 2017

(54) EXPERT SIGNAL RANKING SYSTEM

(71) Applicant: ALAN GUNSHOR, SUNNYVALE, CA (US)

(72) Inventors: ALAN GUNSHOR, Sunnyvale, CA (US); RUSSELL DEWEY, Los Altos, CA (US); OWEN RUBIN, Oakland, CA (US)

(73) Assignee: ANSWERTO LLC, SUNNYVALE, CA (US)

(21) Appl. No.: 14/267,649

(22) Filed: May 1, 2014

(51) Int. Cl. G06F 7/24; G06F 17/30; H04L 29/08

(52) U.S. Cl. CPC G06F 7/24; H04L 67/306; H04L 67/20; H04L 67/02; H04L 67/22; G06F 17/30705

(57) ABSTRACT

In an example, disclosed is a method of ranking and re-ranking a social networking service member's expertise and skills by collecting, analyzing and presenting signals from a member data set.

An expert signal ranking system for a social network is described, where members have their skills validated not only by the endorsements of other members, but also by, and not limited to, many other available member-specific, member-generated, and social signals, whether endorsed or suggested by other members or by the systems described herein. For example, in a collaborative software development network or an expert marketplace, skills are used based on what members contribute and what they discuss, whether with each other or with third parties.

Collecting, analyzing, verifying, and re-ranking these signals can provide a more meaningful validation of a member's skillset than the old way of asking a person for an endorsement. An expert signal ranking system can also reduce the risk of hiring the wrong person, reduce the time it takes to find people with a certain skillset, discover related skills that a member may want to supply or an employer may want to demand, make it easier to post a job description, make it easier to update your resume, make it easier to keep track of your work history, personalize according to your preferences.

An expert signal ranking system can also make assumptions that allow us to be more concise, current, organized, and directed. For example, every law school graduate takes basic courses in contract law, criminal law, torts, and business law. Yet, this expertise can only be assumed by current systems, whereas with the expert signal ranking system these signals can be retrieved because the system re-ranks uncategorized and mis-categorized signals using a machine learning feedback loop.

### BACKGROUND

A social networking service is a computer or web-based application that enables users to establish links or connections with persons for the purpose of sharing information with one another. Some social networks aim to enable friends and family to communicate with one another, while others are specifically directed to business users with a goal of enabling the sharing of business information. Still others are specifically directed to enabling the collaboration on specific projects, where successful collaboration requires the use of specific skills. In one example, when such a contribution is made by the member to a third party (i.e. the owner of the project), this data becomes a signal. That signal can be collected, analyzed, processed, and verified. The owner's acceptance of the contributor's work can, by proxy, also be a validation of the contributor's skills to produce such contribution, and become yet another member data signal.

### SUMMARY

In an example, disclosed is a method of assigning a signal rank on a social networking site by retrieving from non-volatile storage a plurality of member profiles created by a plurality of members of a social networking service, running a text classification algorithm to determine which of the plurality of members possesses a signal that matches any of a plurality of provided signals and associated signal attributes, and for at least one signal of the plurality of provided signals, identifying the plurality of members that possess the signal and ranking the plurality of members relative to one another using a ranking algorithm, the ranking algorithm being based in part upon weighted interactions among the plurality of members that possess the given signal, the weighted interactions comprising endorsements, contributions to a relevant collaborative project, or analysis of stored conversations, between a first member who possesses the given signal and either a second member who possesses the given signal, or an authoritative source who can serve as the validating function in place of the second member.

In another example, disclosed is a system with a retrieval module to retrieve a plurality of member profiles created by a plurality of members of a social networking service, a tagging module executable on one or more computer processors to run a text classification algorithm on the plurality of member profiles to determine which of the plurality of members possesses a signal that matches any of a plurality of provided signals and associated signal attributes, and a ranking module configured to: for at least one signal of the plurality of provided signals, identify the plurality of members that possess the signal and rank them relative to each other using a ranking algorithm, the ranking algorithm being based at least upon weighted interactions among members that posses the given signal, the weighted interactions comprising endorsements, contributions to a relevant collaborative project, or analysis of stored conversations, between a first member that possesses the given signal and either a second member who possesses the given signal, or an authoritative source who can serve as the validating function in place of the second member.

In yet another example, disclosed is a machine-readable storage medium including instructions, which when executed on the machine, causes the machine to retrieve from non-volatile storage a plurality of member profiles created by a plurality of members of a social networking service, execute, a text classification algorithm to determine which of the plurality of members possesses a signal that matches any of a plurality of provided signals and associated signal attributes, and for at least one signal of the plurality of provided signals, identify the plurality of members that possess the signal and rank the plurality of members relative to one another using a ranking algorithm, the ranking algorithm being based in part upon weighted interactions among the plurality of members that possess the given signal, the weighted interactions comprising endorsements, contributions to a relevant collaborative project, or analysis of stored conversations, between a first member who possesses the given signal and either a second member who possesses the given signal, or an authoritative source who can serve as the validating function in place of the second member.

These examples can be combined in any permutation or combination. This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 shows one example method of the current disclosure.

FIG. 2 shows an example method of obtaining a standardized list of signals.

FIG. 3 shows an example method of seed phrase extraction.

FIG. 4 shows an example method of seed phrase disambiguation.

FIG. 5 shows an example association matrix.

FIG. 6 shows an example method of phrase de-duplication.

FIG. 7 shows an example method of phrase validation.

FIG. 8 shows an example method of signal tagging.

FIG. 9 shows an example method of calculating member behavior metrics.

FIG. 10 shows an example method of ranking members.

FIG. 11 shows an example signal graph.

FIG. 12 shows additional steps in some examples of ranking members.

FIG. 13 shows an example social networking site customization system.

FIG. 14 shows an example social networking system.

FIG. 15 is intentionally left blank.

FIG. 16 is intentionally left blank.

FIG. 17 shows an example of a feedback loop using machine learning to categorize previously uncategorized signals.

FIG. 18 shows an example computer system.

In the drawings, which are not necessarily drawn to scale, like numerals may be associated with similar components shown in different views. Like numerals having different letter suffixes may represent different instances of similar components. The drawings illustrate generally, by way of example, but not by way of limitation, various embodiments discussed in the present document.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. A social networking service is an online service, platform or site that allows members to build or reflect social networks or social relations among members. Typically, members construct profiles, which may include personal information such as name, contact information, employment information, photographs, personal messages, status information, links to web-related content, links to code repositories, links to client-side online paste bins, blogs, and so on. Typically, only a portion of a members profile may be viewed by the general public, and/or other members.

The social networking site allows members to identify, and establish links or connections with other members in order to build or reflect social networks or social relations among members. For instance, in the context of a business networking service (a type of social networking service), a person may establish a link or connection with his or her business contacts, including work colleagues, clients, customers, and so on. With a social networking service, a person may establish links or connections with his or her friends and family. A connection is generally formed using an invitation process in which one member “invites” a second member, or an authoritative source to form a link. The second member or authoritative source then has the option of accepting or declining the invitation.

In general, a connection or link represents or is otherwise associated with an information access privilege, such that a first person who has established a connection with a second person is, via the establishment of that connection, authorizing the second person to view or access non-publicly available portions of their profiles. Of course, depending on the particular implementation of the business/social networking service, the nature and type of the information that may be shared, as well as the granularity with which the access privileges may be defined to protect certain types of data may vary greatly.

In the context of business social networks, users often may submit a list of signals that they possess as part of their member profiles. Other users, advertisers, and businesses may then use these signal lists to ascertain what a particular member is good at or interested in. The inherent problem with using member-submitted signals is that it is entirely subjective and prone to fraud. Thus a member may present him or herself as having a signal they do not possess. In addition, even though a member may possess a certain signal, there is no indication that they are proficient in that signal.

The present disclosure describes a method, system and product for identifying a set of standardized signals from member profiles of a social or business networking service. The list of standardized signals, along with information in a member profile section of the social networking service may be used to identify members of the social networking service that possess one of those identified signals. Members identified as possessing a given signal may be ranked relative to one another with respect to the given signal based upon various implicit, explicit, internal and external factors. The signals and rankings may be used to deliver content and customization to those members and others.

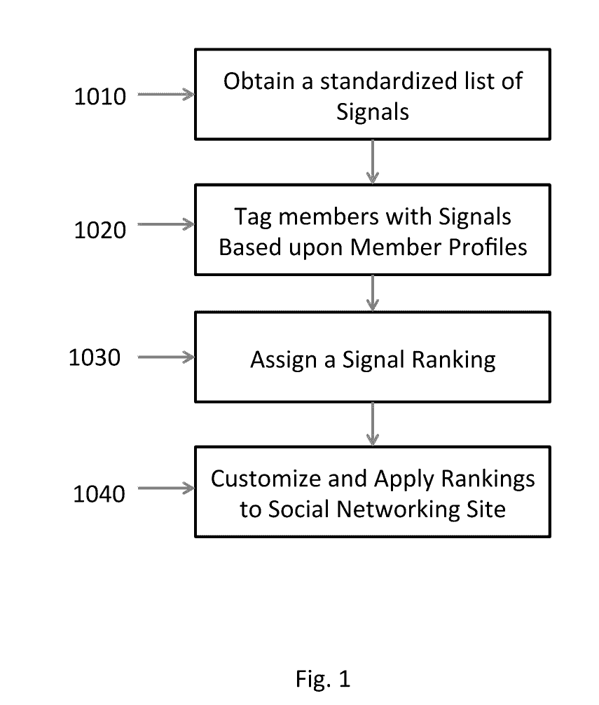

FIG. 1 presents a high level view of the method according to one example implementation. In step 1010, according to one example implementation, the system may obtain or generate a standardized list of signals with which to rank users relative to one another. With some embodiments, these signals may include specific signals such as the ability to program in a particular programming language, such as Java or C++, or broader signals, such as the ability to program a computer, or specialized signals such as programming web-based applications. While reference is made to signals in the present disclosure, it will be understood by those signaled in the art with the benefit of the present disclosure, that the techniques taught herein are applicable to other concepts.

The standardized list of signals may be obtained by utilizing a pre-determined list of signals. In one example, the predetermined list of signals may be manually generated, but in other examples the pre-determined list of signals may be automatically generated. In still other examples, the list of standardized signals may be created by processing member profiles of a social or business networking service. In some examples, this processing can be done automatically using a computing system or other machine. In yet other examples, this processing could be manually accomplished. In some examples, a signals section of a member profile of a social networking service may be used. The signals section of the member profile may be a free-text section that allows users to freely type in signals they possess, this information is generally referred to as unstructured information. Alternatively in some other examples, the member profile signals section may be implemented as a list that allows users to choose a signal based upon structured data such as a predetermined listing of signals, or in other examples, the signals section may be implemented as some combination of unstructured data such as free-text and structured data such as a pre-determined list selection.

In step 1020, the system may then determine, or “tag” members of the business or social networking service who possess one of the standardized signals. In some examples, “tagging” can include associating an item of meta-data with the member profile of the member who is tagged that indicates that this member possesses a certain signal. In other examples, information about which signals a member possesses may be included directly in the member's profile. In one example, members are tagged based upon the information in their member profile in a social networking service. In other examples, members may select signals they are proficient in from a list of the standardized signals. In still other examples, other members may determine a particular member's signals by use of feedback mechanisms such as surveys. In still other examples, other members from other social networks may indirectly determine a particular member's signals by collaborating with that person on a project and by accepting the member's contribution. In still other examples, other members from other social networks may indirectly determine a particular member's signals by collaborating with that person by answering their question.

In step 1030, the system may then rank all the members who have been tagged as possessing certain signals relative to one another to achieve a signal ranking. In one example, the signal ranking is based upon activities that occur on the social networking service. Thus for example, a member who has many connections to other members who also possess the signal would be more highly ranked than other members who have fewer connections to other members who possess the certain signal. In other examples, these connections may be weighted such that a connection to another member who is highly rated for that signal increases the member's ranking more than a similar connection with a lower ranking member. In still other examples, other factors are used to rank members in conjunction with, or instead of, activities on the social networking service. In some examples, authorship of scholarly articles on or about the signal is considered. Authorship or editorship of articles, websites, bogs, software code, answers to published questions, stored conversations (ie XMPP, Web RTC, searchable transcripts of audio phone conversations), Wikipedia entries, or discussion groups or forums may also be considered in other examples.

In step 1040, the rankings and tagging of signals may be used to provide various customization and services to the social or business networking service and its various members. In some examples, members may be provided their rankings. In still other examples, lists may be created and published. In yet other examples, companies and geographical areas may also be ranked using the ranking of individuals who work, live, or are from specific companies or locations. In still another example, recommendations may be generated to members on how to improve their signal ranking.

### Obtainng a Standarized List of Skills

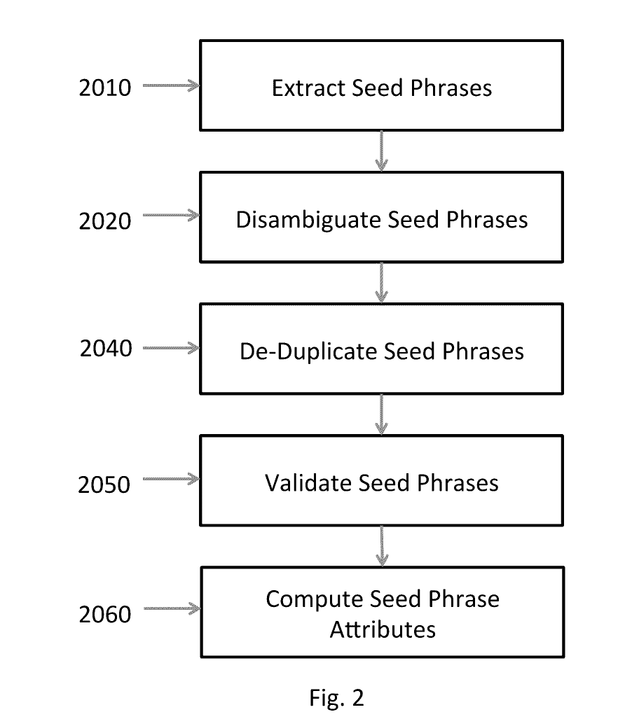

Turning now to FIG. 2, one example method of obtaining a standardized list of available signals is shown. In step 2010, seed phrases may be extracted from text contained in member profiles of members of the business or social networking service. In following steps, seed phrases may be disambiguated (2020), de-duplicated (2040), validated (2050), and have attributes computed for them (2060). Seed phrases in one example are one or more words that represent a possible signal. The seed phrases may be individual words such as “Java” or phrases of words such as “java.net,” or “search and seizure.” In one example, the seed phrases may be extracted from a signals section of the member profiles, but in other examples, seed phrases may be extracted from other sections of a member's profile. In one example, the signals section of a member's profile is a free text (e.g., unstructured) section that allows members to type in any signals they feel they possess. In some examples, all member profiles of a social networking service are used to gather seed phrases, but in other examples, only a subset of all member profiles may be used. For example, the system may only extract seed phrases from profiles of members in a particular industry, in a particular geographic region, or who work for a particular company.

Along with gathering the signal seed phrases, context information, or “meta data,” may be gathered. One such item of meta data may include co-occurent phrases. Co-ocurrent phrases are words or phrases that occur in the same member profile as the seed words or phrases and are used in a later processing operation as one way of ascertaining an intended meaning of a seed phrase. A given phrase may be a co-occurrent phrase for a particular signal seed phrase, and may be a signal seed phrase itself.

Additionally, this meta data may include other information in the member profile of the members in which the seed phrase exists, including a member's reported industry, institution, employer, projects, geographic location, group membership, frequently used code strings in his member data, and the like.

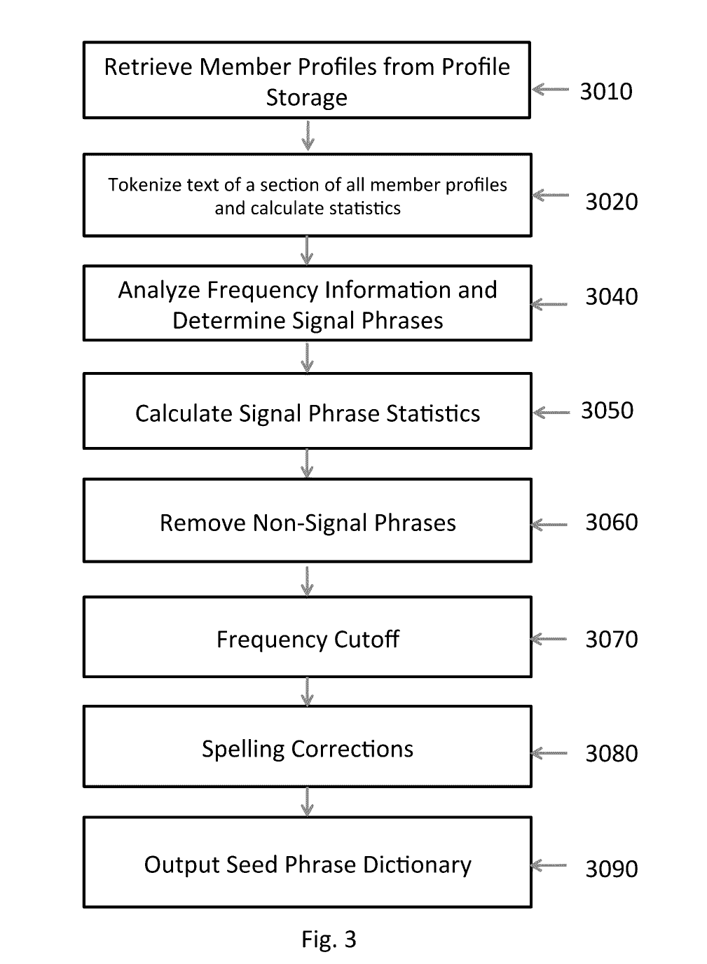

FIG. 3 presents one example of the operations performed to extract seed phrases from member profiles. In step 3010 member profiles from a social networking or business networking site are retrieved from an electronic storage area. The electronic storage area may include computer memory, both non-volatile and volatile, a computer database, another computer system, or the like. In some examples, all member profiles are retrieved, but in other examples only certain member profiles may be included in the signal seed phrase extraction. These selected member profiles may be selected based on a variety of factors. Some factors may include a predetermined list of members, members listing an association with a particular school, organization, work environment, workplace, geographic location, signals listed, signals verified, questions answered, and member popularity.

In step 3020, the specialties section is retrieved from the member profiles. For instance, with some embodiments, the specialties section is that portion of a member's profile that stores the member's self-described or selected signals, or specialties. Each specialties section may then be tokenized based upon commonly used delimiters such as a comma, slash, carriage return, conjunctive or disjunctive words (“and,” “or”), and the like. Tokenization is the process of breaking a stream of text up into words, phrases, symbols, or other meaningful elements called tokens. Thus for example, a member's specialties section of a profile might contain the text “construction industry, housing and development, foundations/support.” The system may initially tokenize this into “construction industry,” “housing”, “development,” “foundations,” “support.” Once the text is tokenized, the system calculates the number of times a particular token is found in the specialties section of the member profiles of the system. The member specialties section is used herein for illustrative purposes, and as already stated, other sections may be used to establish the signal seed phrases.

In some examples, certain aspects of the present disclosure, including tokenization may be done in parallel using a batch processing system over a distributed computer system. In some examples, this distributed computer system may be managed by Apache Hadoop, which is a software framework that supports data intensive distributed applications developed by the Apache Software Foundation, Inc. In some examples, certain aspects of the present disclosure, including tokenization may be implemented by the MapReduce software method which is a framework for processing huge datasets on distributable problems using a large number of computers (or nodes) which are referred to as a cluster. MapReduce is described in U.S. Pat. No. 7,650,331 issued to Dean, et. al. and assigned to Google Inc., of Mountain View, Calif., which is hereby incorporated by reference in its entirety. In MapReduce, there are two phases: the map phase and the reduce phase. In the “map” phase, “chunks” of data are assigned to different servers which then process the data according to a defined algorithm and return a result. The servers may break up the data into even smaller chunks and assign each smaller chunk to a map process running on the server, where many map functions may execute on a single server. The results from all the map processes are then aggregated according to a predefined process in the “reduce” phase.

In the case of the tokenization in step 3020, the data may be chunked for the map phase into any portion or subportion of the input data used to create the standardized list of signals. In some examples, the chunks may include a plurality of profiles, a single profile, sections of profiles, or even sections of text from a portion of a profile, for example, the specialties or signals section. The map processes may then tokenize the given data chunk by parsing the given data chunk and splitting it into words or phrases based upon the delimiters used. Each map process then returns each token to the reduce process. The reduce process may then count the number of times a particular token has been passed back by all the various map processes, establishing a token frequency. In some examples, this map-reduce frequency calculation may be done multiple times. The first passes may use a minimal set of delimiters whereas additional passes may add additional delimiters. This may result in establishing frequency statistics for both longer phrases (“search and seizure”) as well as constituent individual words (“search,” and “seizure), which in some examples may be used in later stages.

While distributed computing methods using MapReduce are described throughout this disclosure, it will be appreciated by a person who is signaled in the art with the benefit of the present disclosure that other methods are possible. For example, a single computer system may do all the processing described as opposed to a distributed computing system. Also, instead of MapReduce, other solutions may be used, including but not limited to, the use of “if-then” and “for loop” programming techniques to iterate over all the member profiles and signals section text in order to tokenize and count token frequency, and perform other method steps of the present disclosure. In addition, other distributed computing solutions may be utilized apart from Hadoop. Alternative distributed computing approaches may be employed such as Message Passing Interface (“MPI”) or a cluster of workers with a single master node to partition out parsing tasks.

In step 3040, the frequency of token occurrence information may be used to determine whether two different tokens correspond to a specific signal phrase and therefore should not be separated by the tokenization. For example, the phrase “search and seizure,” might be broken up in step 3020 into “search” and “seizure,” however the signal phrase “search and seizure,” would be best kept together as it likely refers to one signal. Some signal phrases such as “C++ and Java” should be broken apart into “C++,” and “Java,” as those are considered separate signals. In some examples, whether or not to split the seed phrases may be determined by calculating whether any of the component tokens occurred individually less often than the compound phrases. If not, then the component tokens will be kept separate, otherwise they will be combined. Thus for example, frequency information for “search,” “seizure,” and “search and seizure” may be calculated. If “search” appeared 5 times and “seizure” appeared 3 times, but “search and seizure” occurred 10 times, then the signal seed phrase may be the compound phrase “search and seizure.”

In step 3050, this first pass data may be fed back into the system to scan member profiles again to determine a count of how many times each phrase occurs in the member profiles. In some examples, this may be done using MapReduce and Hadoop as in step 3020. In this case however, instead of splitting at the selected delimiters automatically, the system may use the analysis performed in step 3040 to come up with a refined splitting algorithm. Thus, for example, instead of splitting “search and seizure,” the system may treat it as a single phrase in producing a frequency count if the analysis in step 3040 indicates it should be treated as such. In some examples, this may be an iterative process and the data may be fed back into scan member profiles again, each time with a refined splitting algorithm until the list of signals converges.

In step 3060, certain non-signal seed phrases may be removed from further consideration. Thus phrases clearly not relating to signals may be removed. For example, phrases corresponding to certain categories of language not likely to be signal related may be removed. In some examples, articles, prepositions, verbs, nouns, or any combination may be removed. In some examples, phrases that may be inappropriate, offensive or too graphic may be removed. Various methods may be used to achieve this, including submission of the phrases to crowd-sourcing jobs, dictionaries, or blacklists A “blacklist” is a list that contains common non signal phrases. If a signal phrase is on the blacklist, it may be removed from further processing. In some examples, this operation may be done prior to tokenization after the member profile section is read from storage.

In step 3070, in some examples, statistically insignificant seed phrases may be removed from further consideration. Thus if the frequency of occurrence of a signal seed phrase is below a threshold, that particular signal seed phrase may be removed from further consideration. Thus, for example, if only one profile out of thousands contains the signal seed phrase, that seed phrase may not be particularly interesting. This allows the size of the signal seed phrase list to be reduced. The threshold may be a predetermined value that indicates a minimum number of times the phrase must occur (e.g., 10 times) to be included, or a predetermined percentage (e.g., it must be included in 0.5% of the scanned member profiles), or some other dynamic algorithm.

In 3080, in some examples, a spelling checker and correction algorithm may be used to find and correct spelling deficiencies in the signal seed phrase list. This is to shrink the size of the signal seed phrase list and make the task of de-duplication easier in later stages by eliminating improperly spelled variants. This may be desirable for signal seed phrases in which misspellings are common.

In step 3090, the resulting list of signal seed phrases not removed from consideration may be output and may be called the “Seed Phrase Dictionary.”

In examples in which the set of standardized signals is determined based upon a free-text area of a member's profile, the various collected seed phrases may be ambiguous. That is, phrases may have more than one meaning, or “senses,” and subsequently refer to different signals. For example, the text “search,” in a user's signal section of a profile, may refer to a law enforcement context, or it may refer to an internet search context, or it may be a talent search context.

Returning now to FIG. 2, because of this problem, in some examples, the next step in obtaining a standardized list of signals may be phrase disambiguation carried out in step 2020. In phrase disambiguation, the list of signal seed phrases may be expanded to capture the different “senses” of the phrases. “Senses” are different meanings of a given phrase. So, for example, if the list of signal seed phrases initially is “search,” and information is found in the member profiles to suggest several different senses of “search,” then the list of signal seed phrases may be expanded to include all or some of the particular senses. Additionally, the signal seed phrases may be annotated to identify the sense. Thus the list of signal seed phrases might expand from one phrase to three (i.e., “search” becomes “search” in the computer science sense, “search,” in the law enforcement sense and “search” in the recruiting sense).

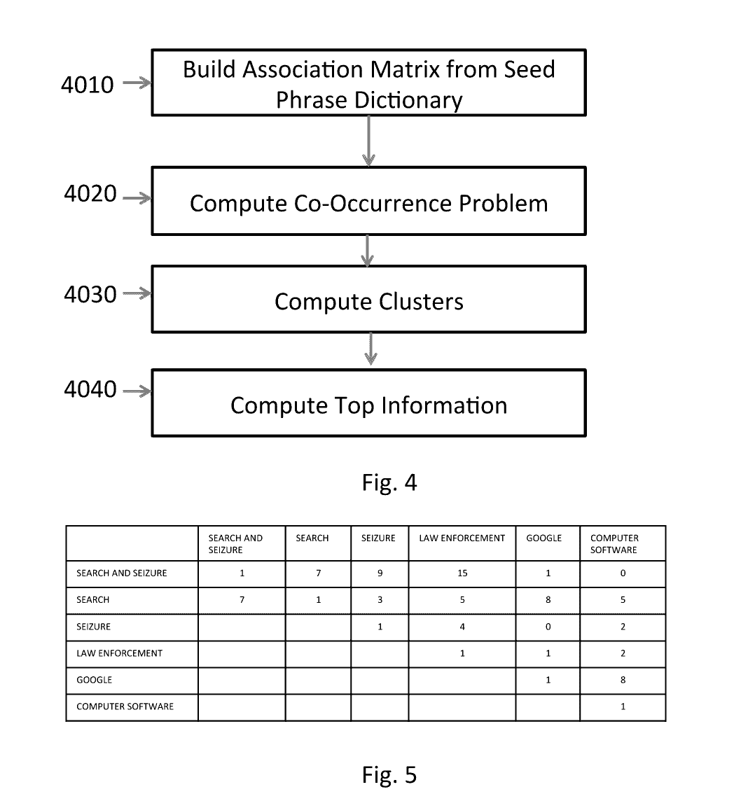

FIG. 4 shows one example implementation of a disambiguation algorithm. In step 4010, an association matrix may be built by reprocessing the signals section of the member profiles again. The MapReduce functionality may be programmed to emit a count of a co-occurrence of each pair of terms in the seed phrase dictionary for every member profile. A co-occurrence is an instance where two seed phrases occurred in the same member profile. Thus if there are ten terms in the seed phrase dictionary, the association matrix may be a ten-by-ten matrix, each row and column intersection in the matrix corresponding to a count of the number of times the pair of dictionary seed phrases occurred in the scanned member profiles.

FIG. 5 depicts a basic example of an association matrix that shows the co-occurrence of six dictionary seed phrases. Thus, for example, the term “Search and Seizure” occurred in the same profile as the term “Law Enforcement” 15 times, whereas it never co-occurred with the term “Computer Software.”

In step 4020, a probability analysis may be run using the association matrix to determine, based on a given signal seed phrase, what the likely co-occurrent phrases are. This may be expressed as a probability that given a signal seed phrase, a different phrase will be in co-occurrence.

Thus, in FIG. 5, the probability that “Search and Seizure” was present in the same profile as “Law Enforcement” will likely be very high. In some examples, this algorithm may include various similarity metrics like Jaccard Similarity or Term Frequency Inverse Document Frequency (TFIDF).

In step 4030, the probabilities may be used to “cluster” the various related seed phrases into senses using the calculated probabilities. The seed phrases may be clustered based upon the probability that certain co-current terms of the signal seed phrases will occur with other co-occurrent terms. Thus for example, if “search” has a high probability of being co-occurrent with the signal seed phrases “law enforcement,” “fbi”, “computer programming,” and “Java,” the system may use the co-occurrent information between those likely co-occurrent phrases to determine “clusters” of “search.” Thus for example, if “law enforcement” had a high probability of being co-occurrent with “fbi” and “fbi” had a high probability of being co-occurrent with “law enforcement,” but NOT “computer programming,” and NOT “Java,” then one cluster may be “search, law enforcement, fbi.” If Java and computer programming are likely co-occurrent phrases between themselves, then another cluster could be “search, Java, computer programming.”

To perform this clustering, an expectation maximum algorithm may be used. For example, an algorithm such as K-means may be used. Co-occurrent phrases may be compared with each other pairwise in the space of all frequently co-occurring or similar phrases for the seed-phrase. Rows of this distance matrix may then be clustered, and clusters may be merged or split as needed until a converged set of disambiguated phrase senses emerge.

In step 4040, the top industry information for each cluster may be computed. This may be done by processing the member profiles using Hadoop and MapReduce again. In this case, the member profiles may be searched for the various dictionary signal seed phrases. Upon finding a dictionary signal seed phrase, the system may read the industry association stored in the member profile. The industry association in some examples is a member-selected industry association. In some examples, the member may select from a predetermined list of industries. In other examples, the industry association may be a free form text association. The clusters may then be analyzed to determine the top industries associated with the signal seed phrases in that cluster. This information may then be stored and used in later stages.

The output of the disambiguation may result in a list of disambiguated signal seed phrase clusters annotated with industry information. Because the member profile section may contain typos, or different spellings or words to describe a single signal (such as “Java net” vs. “java.net”), and because the result of the disambiguation may sometimes lead to signal duplications the disambiguated signal seed phrases may need to be de-duplicated. De-duplication is the process by which duplicate signal seed phrases are removed from further consideration.

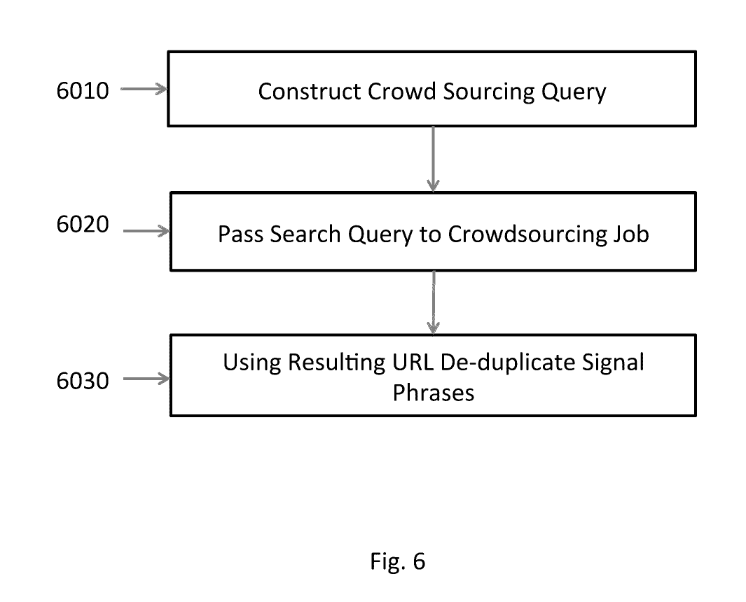

Continuing with FIG. 2, in step 2040, the disambiguated signal seed phrases may then be de-duplicated. FIG. 6 shows one example method for de-duplicating the seed phrases. In step 6010, a Wikipedia or other internet search query may be generated using, in some examples, the signal seed phrase, co-occurrent phrases, and/or industry information. In some examples, only the disambiguated signal seed phrase itself is used. In other examples additional information such as co-occurrent phrases, and/or industry information may be used. This internet query may be constructed as merely a concatenation of all the information regarding the signal cluster, such as for example: “search search and seizure law enforcement FBI police sheriff DEA drug enforcement agency.” Some other examples may use Boolean operators such as ‘and’, ‘or’, ‘not’, or ‘xor’ between the various pieces of the search query. Alternatively, the query may be compared against text collections or web pages stored offline using an inverted index or text similarity metrics applied against a document collection.

When the internet web query is executed in an internet or other search engine a list of internet web pages representing a list of possible matches for that query may be produced. In some examples, the internet search engine may be an internet-wide search engine such as Google, run by Google Inc. of Mountain View, Calif. In some examples, the search engine may be a site-specific search engine, such as the search engine of Wikipedia. Wikipedia is a searchable, online, collaborative encyclopedia project supported by the Wikimedia Foundation, a Florida Corporation headquartered in San Francisco, Calif. In some examples the internet web query, when executed in Wikipedia, may return a list of Wikipedia entries corresponding to pages of the Wikipedia.

At step 6020, the signal seed phrase, the co-occurrent phrases, the industry information, and the Wikipedia or other internet search engine query may be passed to a crowdsourcing job of a crowdsourcing application. Crowdsourcing is the act of outsourcing tasks to an undefined, large group of people or community through an open call. In one example implementation of crowdsourcing, a problem or task is broadcast to a group of individuals looking for tasks. Those with an interest in solving the problem decide to accept the task. Once a solution is found, the solution is passed to the party who posed the problem or task. Usually, a small payment is then provided to the party who solved the problem by the party who posed the problem. One example crowdsourcing implementation is Mechanical Turk™ run by Amazon.com, Inc. of Seattle, Wash., in which Amazon provides a marketplace in which businesses post tasks that need completion and offer a reward for completing the task. The reward may be any monetary value, but generally is a small reward of a few pennies per task. Individuals looking for tasks then may accept and complete those tasks to gain the reward.

In one example, the job submitted to the crowdsourcing application may ask the worker to pick the Internet web page from the list of internet web-pages returned by the search query that corresponds to the particular signal seed phrase. Thus, in one example, if the signal seed phrase is “search,” with a related concurrent phrase “legal,” the search query might be “search legal,” and may return Wikipedia results such as:

“search and seizure”

“Legally Blonde—The Musical: The Search for ElleWoods”

“JustCite”

“LawMoose” . . .

In that example, the worker would pick “search and seizure” to signify that the particular signal relates to searches and seizures of law enforcement. Other similar signals should return the same page. In this way, in step 6030 duplicate signals may be determined based on common web-pages returned by the crowdsourcing workers.

In some examples, a single signal seed phrase may be submitted to multiple workers. This is to ensure the quality of the worker responses. Each worker would then make their selections, and various algorithms in step 6030 may be used to pick the result if the workers come back with different results. One example algorithm may be a majority algorithm, whereby the page selected by the majority of workers will be selected. Other example algorithms use a consensus pick.

Other examples of de-duplication may be used, such as using the crowd-sourcing worker to sort a list of signal seed phrases to find duplicates using just the signal seed phrases and the co-occurrent phrases and associated industry information. Other implementations may include using the crowdsourcing worker to find a Wikipedia page or other webpage that describes the particular signal without first presenting the worker with a constructed query.

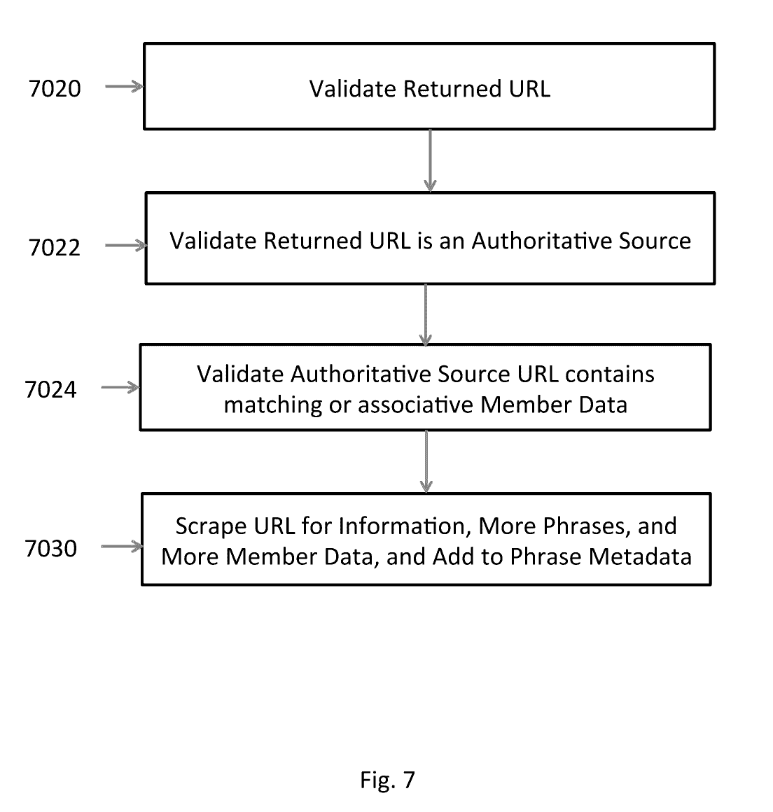

Once the disambiguated signal seed phrases are de-duplicated, the phrases may then be validated in step 2050 of FIG. 2. One example validation method is shown in FIG. 7. In step 7020, the Wikipedia or other URL is validated. In one example, this may be validated by another crowdsourcing job that simply asks the worker to determine if the URL returned correctly corresponds with or describes the signal phrase. In another example, this may be validated by analyzing that a source is authoritative against a list of authoritative sources (7022), an authoritative source set of software code contributions, which can be done as an automated task, or as a manual task, or as a combination of the two. In another example, this may be validated by analyzing an authoritative source set that contains matching or associative Member Data (7024). Other automatic algorithms may be used, including examining the frequency with which the phrases and terms in the signal seed phrase and related meta data (such as the common co-occurrent phrases and industry information) appear in the returned website. A low frequency may indicate an incorrect website that may be flagged for later scrutiny.

In step 7030, the returned URL or Wikipedia entry may be scraped to ascertain more information or member data, such as more related phrases and industries, related questions, unanswered related questions, or related conversations. The result may be added to the signal phrase meta-data and may result in a standardized list of signals and related meta information about those signals that may be used to “tag” individuals with those signals. As already explained, in some examples, the signal phrase meta data may contain co-occurrent phrases, industry information, the names of software projects, and the information scraped from the returned URL, including client-side paste bin URLs, and stored conversation archive URLs.

Referring back to FIG. 2, in step 2060, additional attributes may be calculated by running the member profiles back through the profile processing. Such attributes may include calculating the top industry, related phrases, software project names, and other statistical information about the signal seed phrases. This extra step may be done in some embodiments, rather than collecting this information along with other processing steps above because the signal phrases may be constantly changing. Thus because of the de-duplication above, the statistics kept (i.e. top industry, etc. . . . ) may need to be updated to reflect this de-duplication.

### Tagging and Ranking Members with Signals

Returning now to FIG. 1, once a standardized list of signals and possibly other information such as related terms and industries is determined, members with those signals may be determined in step 1020.

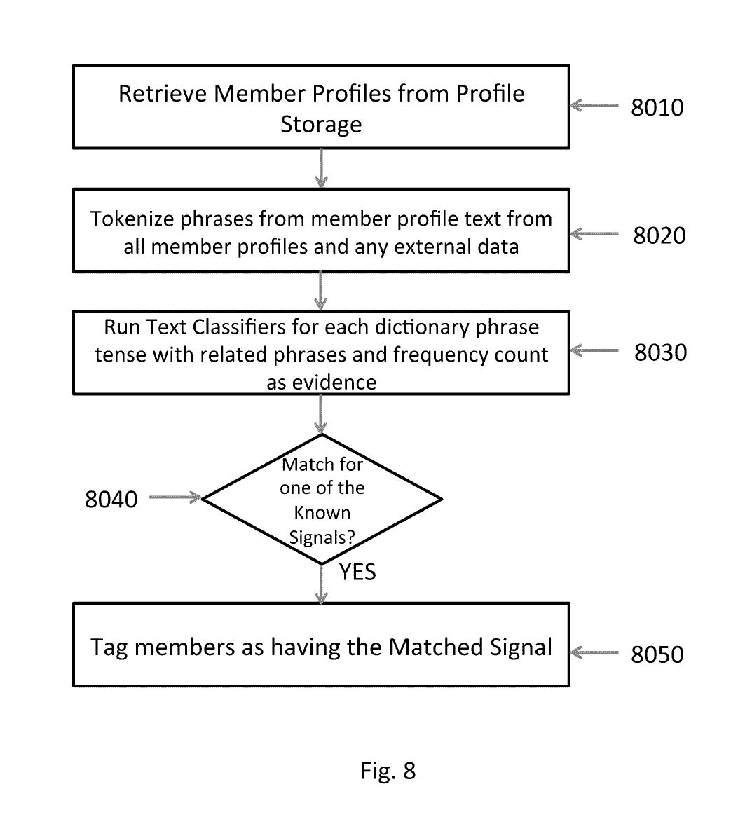

FIG. 8 shows an example method of “tagging,” or identifying members that possess one of the signals in the standardized list of signals. In step 8010, a set of member profiles may be retrieved from a database or other computer memory. In step 8020 information from the member profiles may be retrieved. In some examples, the information may be the text or a segment thereof of the member specialties section of the member profile. In other examples, the information may also include details such as industry information, company information, software package names, or any other piece of information from the member profile including member status updates. In yet other examples, external information from other internet sites may be gathered based upon any link found in a member profile. For example, a website or a blog listed on a profile may be scraped for content that is then tokenized for input into the tagging algorithms. In some examples, if the external site contains another link, that link may then be processed as well.

In step 8030 an algorithm may be used to determine whether, based on all the evidence, a particular member is likely to have a particular signal. In one example, the algorithm may be a Bayesian text classifier. In some examples, there may be a classifier for each signal seed phrase sense that is trained with the signal seed phrase dictionary, related phrases, frequency counts, and/or industry information. In this example, the tokenized phrases of member profile text and external data is fed in as evidence (e.g., input to the algorithm) and the output of the Bayesian classifier is a probability that a particular member possesses a particular signal. Other example algorithms include for example, a neural network, term frequency computations or any text based classification algorithm.

In step 8040, the probability produced by the text classification algorithm at step 8030 may be run through another algorithm to determine whether or not the member should be tagged with a specific signal. In one example, the algorithm may be a threshold value. For example, the threshold could be set so that if the classification algorithm produces a 70% chance that the particular member possesses the given signal, then the member may be tagged as having the particular signal. In other examples, the threshold may vary depending on the application. For example, “tagging” a user with a particular signal for ranking purposes might demand greater certainty than “tagging” a user for advertising purposes. Thus the threshold may be dynamically adjusted based on intended uses of the signal information. In some examples, tagging may be indicating in some fashion in the member's profile that this member possesses the particular signal. For example, meta data representing the signals possessed by the member may be stored in association with a member's profile. In other examples, tagging may be achieved through keeping a separate list of members that possess the particular signal. Tagging may be accomplished through any means in which the system may store an indication of what particular members possess a particular signal or signals. Tagging may also include storing the probability generated in step 8030.

The result of step 8040 is that members possessing a certain signal are identified and tagged at step 8050. The resulting list of members that possess a certain signal may be a community, or network of individuals with that signal. This may be referred to as a signal community.

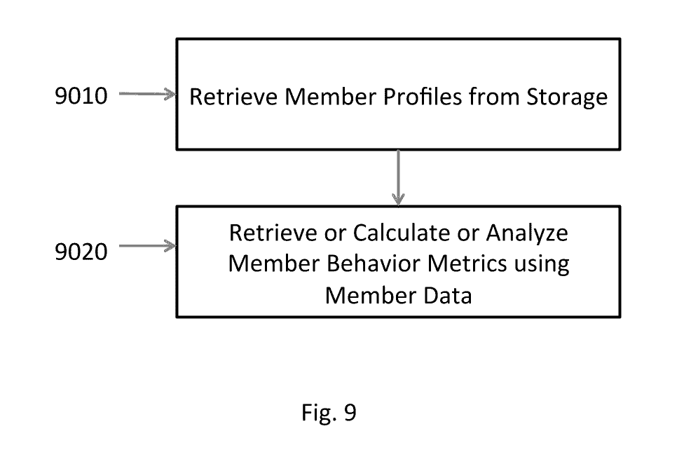

After members with a particular signal have been identified, or “tagged,” those members may be ranked relative to one another. Referring back to FIG. 1, this is step 1030. FIG. 9 shows, in one example implementation, a preliminary step in ranking members.

FIG. 9 shows a collection of member behavior metrics that may be useful in calculating a member's rank in a particular signal. In step 9010 member profiles may be retrieved. In step 9020 member behavior metrics may be collected, derived or calculated. The member behavior metrics may include or be based on information concerning any activity generated by or about the member. In some examples, this may include information about events a member has attended, searches a member has performed, member industry information, how many years of experience the member has, how selective the member is on acceptance of invitations, and the like. In some examples, the behavior metrics may also include endorsement information. The endorsement information includes information relating to an indicator of support or acceptance between individuals. This endorsement information may be not only from the social networking site itself, but also endorsement information from external sites. Endorsements may include data such as profile page views, various follow, mention, and messaging actions on social networks, favorites, shares, upvotes, invitations to connect, acceptance of connections, emails, company relationships, group memberships, location proximity, bookmarks, referrals to that member and from that member, and recommendations. Some example endorsements that may be used include a follower relationship on the microblogging service Twitter, operated by Twitter, Inc. of San Francisco Calif., connections on LinkedIn, run by LinkedIn, Inc. of Mountain View, Calif., friend relationships on Facebook, of Palo Alto, Calif., MySpace of Beverly Hills, Calif., and run by News Corporation, connections on github, run by GitHub, Inc., acceptance of collaborative contributions, questions or answers related to the signal, searchable text from stored conversations, the names of software projects collaborated on, and the like. In some examples, the endorsement or member behavior activity information may also include frequency information that determines the frequency of a particular connection or behavior.

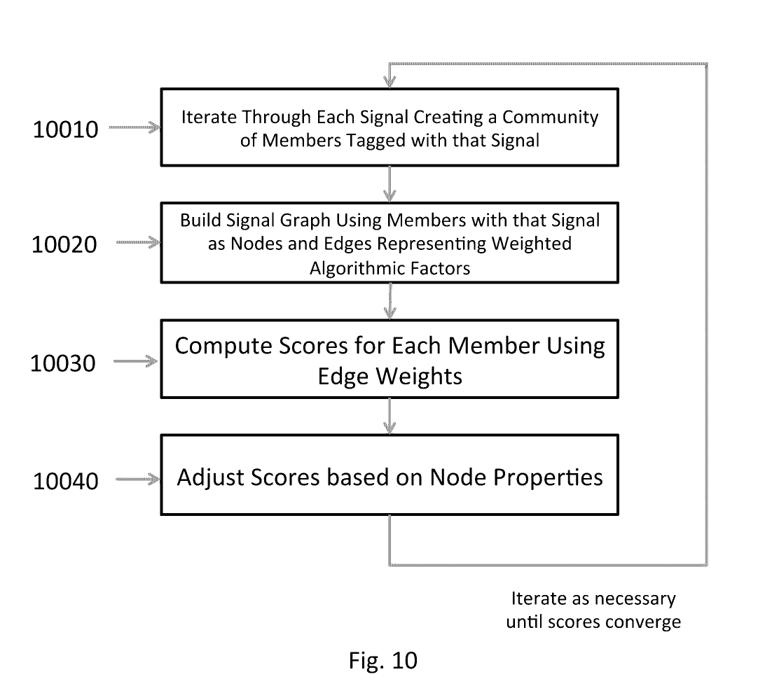

FIG. 10 shows an example ranking algorithm that may be used to rank members relative to one another. In step 10010 the community of members with a particular signal may be ascertained based on the earlier tagging. In step 10020, a directed signal graph may be built using the various members tagged with the particular signal as nodes and edges representing the various behavior and endorsement metrics calculated in FIG. 9 for each member that apply to the relationship between each of the member nodes. Examples include, but are not limited to, connections, profile views, Twitter followership, message sending between the member nodes, referrals, recommendations, and the like. Each edge may then be given a weight depending on the type of edge that is represented. Thus, in one example, a connection in the social network may be weighted more heavily than a page view. Initial scores may then be computed in step 10030 based on the edge weights. In some examples, the weights of the edges are added together to form the initial score. In other examples, other algorithms may be used.

In step 10040, the properties of each node may be examined to adjust the weight of each edge, and thus the initial score. For example, if two members are connected with an edge, but one member never views the other member's page, then that edge may be given less weight. This indicates that the edge between the members may not be that strong because perhaps a user felt socially obligated to be polite and make a connection rather than decline an invitation. In general, in some examples, if a node has very low behavioral metrics that are representative of member interactions with that member (such as such as profile views, messages, and connection information), the value of the weighting of those edges to and from those nodes may be reduced. Alternatively, in some examples, weightings may be increased or decreased based on the member behavior or endorsement metrics. In some examples, the weight for a particular edge may be increased or decreased based on the initial score of the node with which that edge is associated. Additionally, in some examples, scores may be increased or decreased based on employment, industry associations, location of residence, location of employment, education, and other factors and attributes. This may be based upon, in some examples, the statistics collected and calculated in step 2060 of FIG. 2. Thus for example, if a particular individual worked for, or followed a particular company that was important for a particular signal, that particular member's scores may be increased.

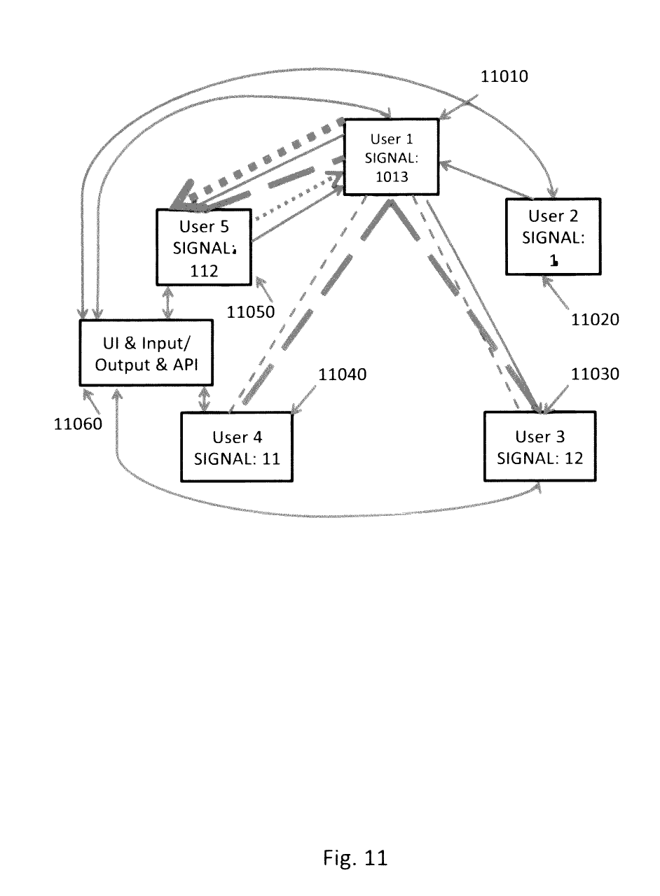

An example signal graph is shown in FIG. 11. In FIG. 11, five users (11010, 11020, 11030, 11040, 11050) are represented as nodes in the graph. The User Interface and Input and Output systems and API they interact with is depicted in 11060. An arrow line represents an endorsement from one member to the other. The recipient of the endorsement is awarded 10 points. A dotted line indicates acceptance of the endorsement and increases the sender's score by five points. A flared arrow indicates a page view and is worth one point for the member whose profile or homepage was viewed. Another dotted line arrow indicates a code contribution to a project is worth 1,000 points for the member who contributed the code. Similarly, a dotted line arrow may also indicate a signal endorsement based on the transcribed text from a stored conversation. Once the edge connections are made, the scores may be calculated. Other scores for each edge connection type may be used; the scores of ten, five, and one for the various behavior metrics are exemplary only. While a simple addition algorithm is demonstrated in FIG. 11, additional algorithms may be used to calculate the scores.

Additionally, once the algorithm has been run once, the algorithm may be re-run, and the strength of the weights to give the various edges may be adjusted based upon the signal rank of the user to which the connection pertains. For example, based upon the initial run presented in FIG. 11, since user 1 has the highest signal level (1013), those with connections with user 1 may have the weight of those edge connections increased. Thus an edge connection with user 1 may be worth 11 points as opposed to 10 points in one example. This algorithm may be run until the scores converge. In some examples, eigenvalue centrality algorithms may be used to rank the graph nodes including degree centrality, betweenness centrality, closeness centrality, and eigenvector centrality. This algorithm in another example may incorporate principles of the PageRank®, or HITS (Hyperlink-Induced Topic Search) link analysis algorithm. The PageRank® algorithm is fully described in U.S. Pat. No. 6,285,999 assigned to Stanford University which is hereby incorporated by reference in its entirety. The HITS algorithm is fully described in U.S. Pat. No. 6,112,202 assigned to International Business Machines which is hereby incorporated by reference in its entirety.

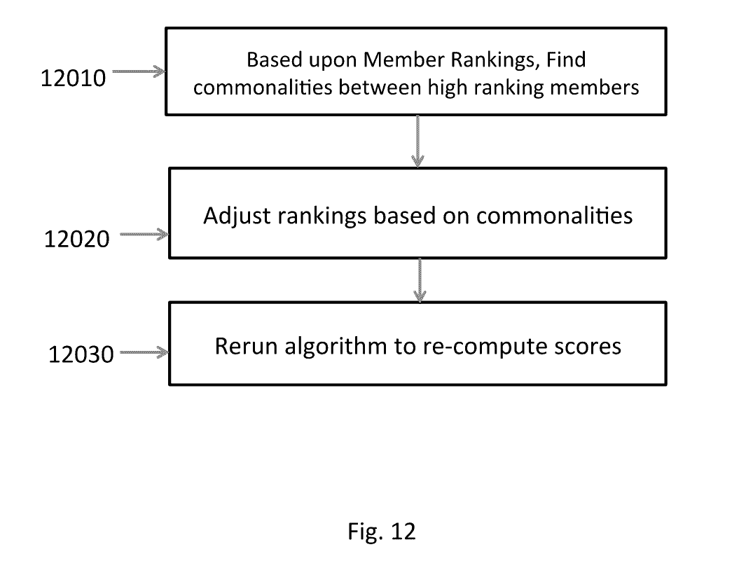

After the scores converge, in some examples, the scores may be modified even further, taking into account certain other attributes. FIG. 12 shows an example method of calculating these other factors. In step 12010 commonalities may be found between members with a particular signal. These commonalities may include identifying which companies employ high ranking members, which schools high ranking members have listed as attending, which geographical locations high ranking members live or work in, which related groups or other social networks high ranking members belong to, and the like. Each of these factors then may be fed back into the ranking process at 12020, such that members of these common groups may have their scores increased or decreased. At step 12030 the member score may then be recomputed using these commonalities by rerunning the algorithm until the scores re-converge. While some of these same factors may have been used in step 10040 of FIG. 10, this step is more accurate as it is based on an actual ranking of the nodes and not just signal seed phrase statistics.

In still other examples, a high ranking in a related signal may be used to increase a member's rank in a particular signal. For example, a high ranking in a signal such as “C++” may increase a member's ranking in a “Java” signal. This may be done by using the phrase attribute statistics collected after phrase validation in the obtaining signals portion, or it may be based on rankings of individuals. For example, the system may examine individuals highly ranked in a particular signal and find out which other signals those individuals are most commonly highly rated in. For example, if most of the highest rated people for the signal “accountant,” also have a high signal level for “tax preparation,” then an individual who has an “accountant” signal may have their “tax preparation,” signal score increased.

In still other examples, the authenticated use of a related signal may be used to increase a member's rank in a particular signal. For example, the use of Java signals in answering questions about or making contributions to a project for NODE.JS may increase a member's ranking in a “Java” signal. This may be done by using the externally-collected phrase attribute statistics collected from an authenticated source like a code repository or a stored conversation, after phrase validation in the obtaining signals portion, or it may be based on rankings of individuals. For example, the system may examine individual use of a particular signal and find out which other signals those individuals are most commonly highly rated in. For example, if most of the highest rated people for the signal “accountant,” also have a high signal level for “tax preparation,” then an individual who has an “accountant” signal may have their “tax preparation,” signal score increased.

### Customization Based on the Skill Rankings

Referring back to FIG. 1, once the signal rankings are assigned, various customizations and application of the rankings may be achieved in step 1040. The signals customization methods and processes which create customized features for the social networking service may be implemented separately, in one example—in a separate signals section of the social networking service, or may be integrated into the social networking system, or any combination of the two. Thus the customizations described may be added onto existing sections or pages of the social networking service, or may be a new, stand-alone section, application, or website. These signal customizations may take the form of HTML, text, JavaScript, FLASH, Silverlight, Chat sessions, paste bin URLs, or any other type of textual, audio, video, audiovisual or other content. Customizations may be delivered as part of the social networking service or as part of some other stand alone application.

In some examples, members may be shown their rankings for each signal they are tagged as having, or in other examples, only certain signals will be shown. In other examples, members may be shown other member's rankings. In some examples, an entire list of all members ranked may be shown. In yet other examples, a top-ten, a top-fifty, or some other segment of the rankings may be shown. In yet other examples, unanswered questions, answered questions, popular projects, incomplete projects, active projects, or some other segment of the rankings may be shown. In yet other examples, members may view information about rankings for signals they are not tagged as having.

In still other examples, a company rank may be computed using the scores of the individuals that represent themselves as working for that particular company. As already noted, this company score may then increase the scores of the individuals that represent that they work for that company. This company rank or score may be displayed to interested users of the social networking service.

In still other examples, a project rank may be computed using the scores of the individuals that represent themselves as working on that particular project. As already noted, this project score may then increase the scores of the individuals that represent that they work on that project. This project rank or score may be displayed to interested users of the social networking service.

In still other examples, a mentor rank may be computed using the scores of the individuals that represent themselves as working on particular mentoring topics or questions. As already noted, this mentor score may then increase the scores of the individuals that represent that they work on that topic or question. This mentor rank or score may be displayed to interested users of the social networking service.

In still other examples, a location or geographic rank may be computed using the scores of the individuals that represent themselves as working or living in that area. As already noted, this geographic rank may then increase the scores of the individuals that represent that they lived or worked in that geographic region. In other examples, the geographic rank may be computed based upon a company rank using the locations of the companies. Thus geographic locations with more highly ranked companies will be ranked higher. This location or geographic rank may be displayed to interested users of the social networking service.

These rankings may be displayed to users to customize the user experience. In some examples, the rankings may be displayed statically in time, but in other examples, the rankings may show trends. Thus geographic trends, company trends, time trends, and other signal trends may be constructed.

In yet other examples, members may be given recommendations on how to improve their rankings in a particular signal. These recommendations may be based upon the calculations used to arrive at the user's ranking.

For example, the ranking may advise a user to seek out another member and connect with them, or advise them to attend a particular school or university, or publish a paper or write a blog on a particular topic. In some examples, a signal page may be created which shows signal-centric information relating to statistics and rankings of the particular signal. In some examples, the signal page may display a list of individuals sorted by rank, a listing of top employers for the signal, a listing of the top geographic regions, a listing of the top groups for the signal on the social networking site, or any other relevant information.

In still other examples, job postings may be customized for a member based upon their signal rank. In some examples, job postings may only appear to members above or below a certain signal rank, or that possess a certain signal. In some examples, job postings may be delivered automatically by the social or business network to members with a specific rank or a rank exceeding or under a specific amount. In some cases, jobs may not be shown, delivered, or available to members that rank too high in the rankings. This may be because employers do not want someone too signaled and therefore expensive.

Job postings may be customizable based upon a combination of signals and rankings. Thus a job posting may be delivered or viewable only to individuals possessing a requisite rank in multiple signals. Thus for example, a job posting may require a member to be highly ranked in both Java and C++.

In other examples, the system may deliver to a third party, such as a job recruiter, a list of members who possess a particular signal or combination of particular signals. In some examples, the system may deliver to the third party a list of members who possess a requisite rank in the particular signal or combination of particular signals.

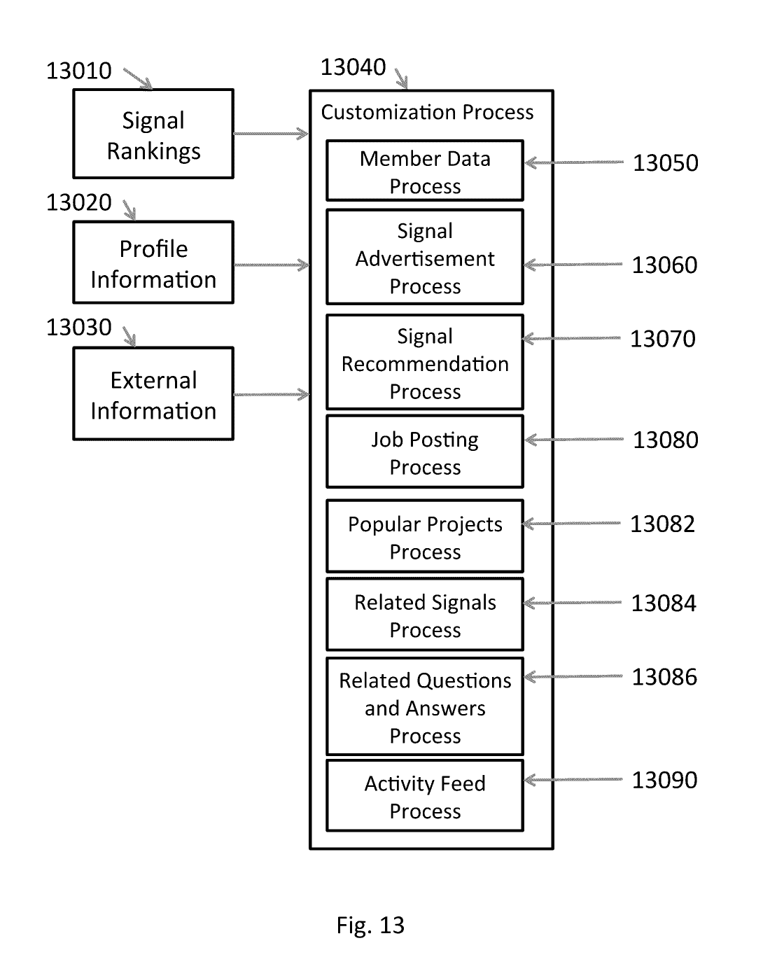

Additionally, advertisements may be customized and delivered to a particular member based upon their signal rank in various signals. For example, an individual who ranks highly in C++ might receive advertisements directed at C++ compilers. These advertisements may even be tailored for a level of product based upon a member ranking. For example, an advertisement for an advanced version of the C++ compiler or an advanced programming textbook may be delivered to users that have higher rankings, and advertisements for basic versions of the C++ compiler or a basic programming textbook may be delivered to lower ranking users. FIG. 13 shows an example system for implementing the signals customization. In FIG. 13, signal rankings 13010, profile information 13020, external information 13030, and accepted project contributions 13032, and stored conversation transcripts 13034, may be used as input into the customization process 13040. The customization process 13040 may include any type of member data process 13050, a signal advertisement process 13060, a signal recommendation process 13070, a job posting process 13080, and an activity feed process 13090. The signal reports process 13050 may be responsible for utilizing signal rankings 13010, profile information 13020, and external information 13030 to prepare and display reports on the signal hierarchy, signal rankings, company or geographical rankings, or other reports.

The signal advertisement process 13060 may be responsible for delivering advertisements to members based upon their signal rankings. This may include storing criteria for various advertisements. These criteria may specify conditions on which the advertisement will be displayed. Conditions in some examples may include an identification of a certain signal or signals that the member must possess prior to displaying the advertisement to the member. In other examples, the conditions may also include a signal level that a member must have in order for the advertisement to be displayed to the member. Thus for example, the conditions may specify that only members above a certain signal level signaled in coding in the C++ computer language may receive an advertisement for an advanced C++ compiler. In one example, the signal advertisement process 13060 may find members who match the criteria, and then may be responsible for causing the advertisement to be displayed to the members.

The signal recommendation process 13070 may be responsible for formulating a recommendation for an interested member on how to improve their signal ranking. The signal recommendation process 13070 may use the activities of the interested member, other lower or higher ranked members, and knowledge of the ranking algorithm itself to suggest changes in member behavior, additional activities, or additional member data types that may increase the member's ranking. In some examples these recommendations may include connecting with certain members, working for a certain company, or living and working in a certain geographic area, and the like.

The job postings process 13080 may be responsible for matching job posting criteria with qualified members. The job posting criteria may include a desired set of one or more signals that a member is interested in, and possibly a desired level of signal. The job posting process 13080 then matches job posting criteria with members that match that criteria and may then be responsible for delivering that job posting to members.

The popular projects using this signal process 13082 may be responsible for matching popular projects with qualified members. The popular projects criteria may be another way to discover a desired user, by employing a desired set of one or more projects that the member is interested in, and possibly a desired role with regard to that project. The popular projects process 13082 then matches project criteria with members that match that criteria and may then be responsible for delivering that list to members.

The related signals process 13084 may be responsible for matching signal criteria with qualified members. The related signal criteria may include a desired set of one or more signals that the member is interested in, and possibly a desired level of signal. The related signal process 13084 then matches related signal criteria with members that match that criteria and may then be responsible for delivering that list to members.

The related questions and answers process 13086 may be responsible for matching questions and answers criteria with qualified members. The related question and answer criteria may include a desired set of one or more signals that the employer is interested in, and possibly a desired level of signal. The related question and answer process 13086 then matches related questions and answers criteria with members that match that criteria and may then be responsible for de ivering that question and answer to members or employers.

The activity feed process 13090 may be responsible for matching activity feed preference criteria with members who use an activity feed page. The criteria used to show an activity on the activity feed may include one or more signals that the member has engaged with a similar activity feed notification item, and possibly a desired level and frequency of notifications to be received. The activity feed process 13086 then matches notification criteria with members to determine whether to show a notification.

### Example Social Networking Service

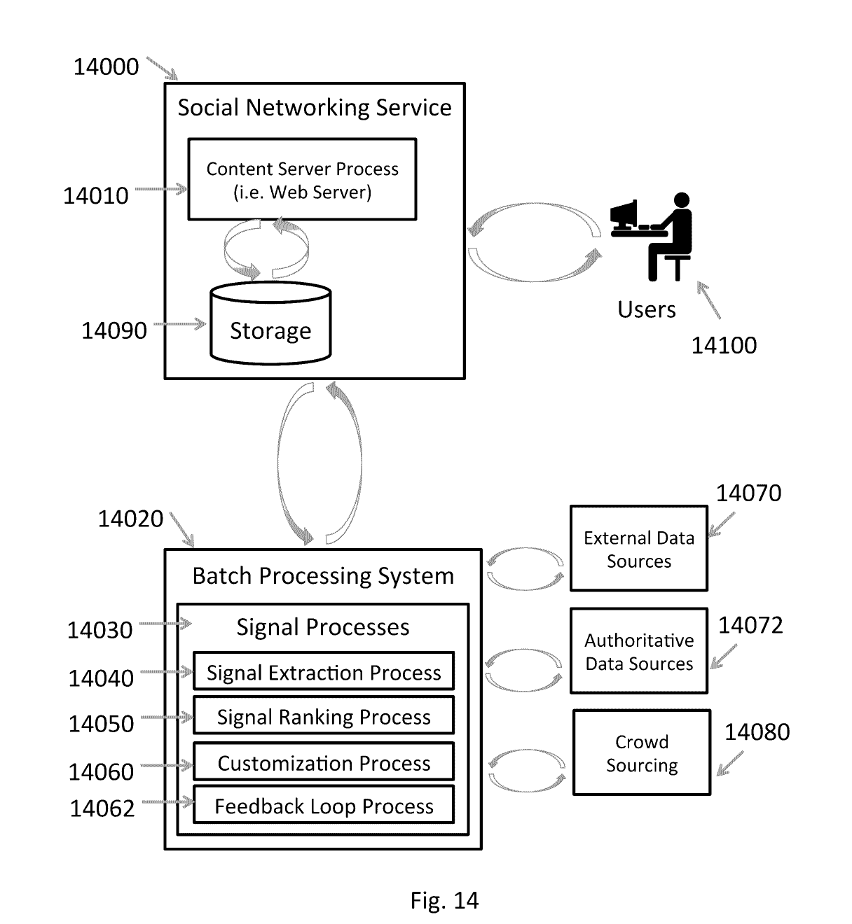

FIG. 14 shows an example social networking service 14000 according to one example of the current disclosure. Social networking service 14000 may contain a content server process 14010. Content server process 14010 may communicate with storage 14090 and users 14100 through a network. Content server process 14010 may be responsible for the retrieval, presentation, and maintenance of member profiles stored in storage 14090. Content server process 14010 in one example may include or be a web server that fetches or creates internet web pages, which may include portions of, or all of, a member profile at the request of users 14100.

Users 14100 may be an individual, group, or other member, prospective member, or other user of the social networking service 14000. Users 14100 access social networking service 14000 using a computer system through a network. The network may be any means of enabling the social networking service 14000 to communicate data with a computer remotely, such as the Internet, an extranet, a LAN, WAN, wireless, wired, or the like, or any combination.

Signal processes 14030 may be responsible for creating the list of signals, ranking members based upon the created list of signals and customizing the social networking service 14000 based upon those rankings. Signal process 14030 in one example may contain a signals extraction process 14040 to create a list of signals based upon member profiles, a signals ranking process 14050 for ranking users relative to each other for each signal in the list of signals, a customization process 14060 which uses the signals and rankings to customize the social networking service 14000 for the members based upon the signal rankings, and a feedback loop process 14062 that uses machine learning to re-rank uncategorized or wrongly categorized signals.

Batch processing system 14020 may be a computing entity which is capable of data processing operations either serially or in parallel. In some examples, batch processing system 14020 may be a single computer. In other examples, batch processing system 14020 may be a series of computers setup to process data in parallel. In some examples, batch processing system 14020 may be part of social networking service 14000. Signal processes 14030 may communicate with the social networking service 14000 to get information used by the signal processes 14030 such as member profiles or data, and to customize the social networking service 14000 based upon the signals and their rankings.

Signal processes 14030 may also communicate with a crowdsourcing application 14080 and various external data sources 14070 across a network. The network may be any method of enabling communication between social networking service 14000 and crowd sourcing application 14080 and/or external data sources 14070 and/or authoritative data sources 14072. Examples may include, but are not limited to, the internet, an extranet, a LAN, WAN, or wireless network. Signal processes 14030 may submit de-duplication jobs through the network to the crowdsourcing application 14080 for de-duplication. Crowdsourcing application 14080 may return the results back over the network. Signal processes 14030 may also utilize a network to access various remote data systems. The various described networks may be the same or different networks.

Signal extraction process 14040 may extract a standardized list of signals from the various member profiles and member data as well as calculating the various statistics and meta data about those signals. Signal ranking process 14050 may rank members based on the provided signals. Customization process 14060 may customize the social networking service 14000 based upon the signal rankings.

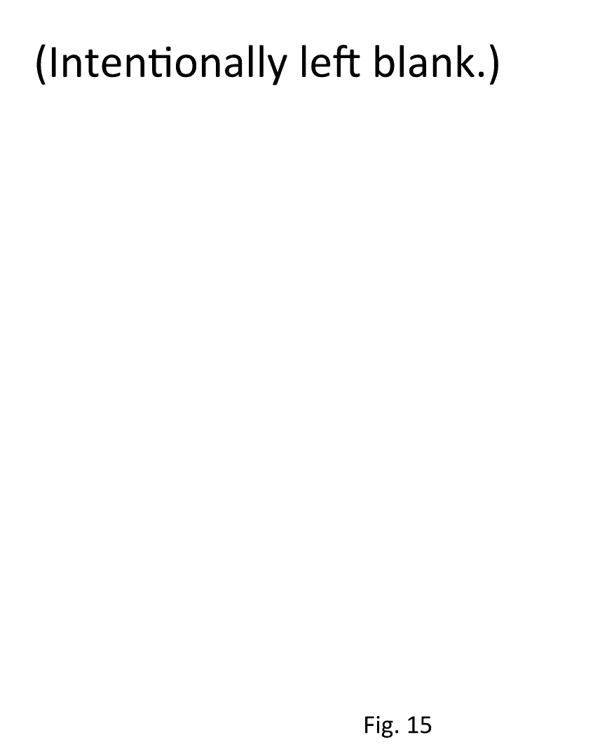

FIG. 15 is intentionally left blank.

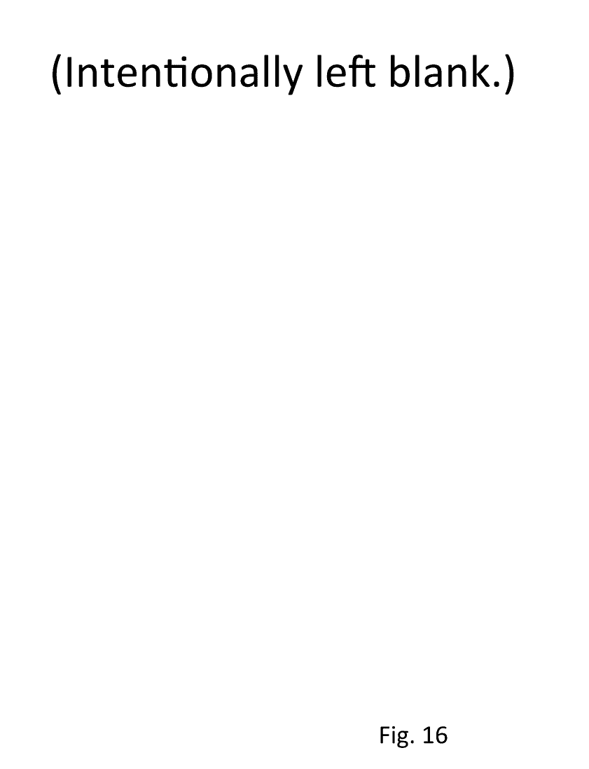

FIG. 16 is intentionally left blank.

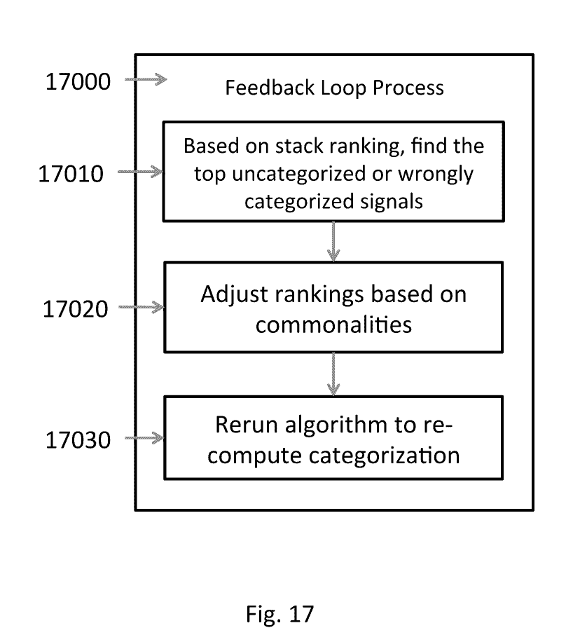

FIG. 17 is a feedback loop process 17000 that may locate the top uncategorized or wrongly categorized signals by using a stack ranking 17010, adjust the rankings based on commonalities 17020, and rerun the algorithm to recomputed categorization 17030.

### Modules, Components, and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations. Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time. Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Computer Architecture

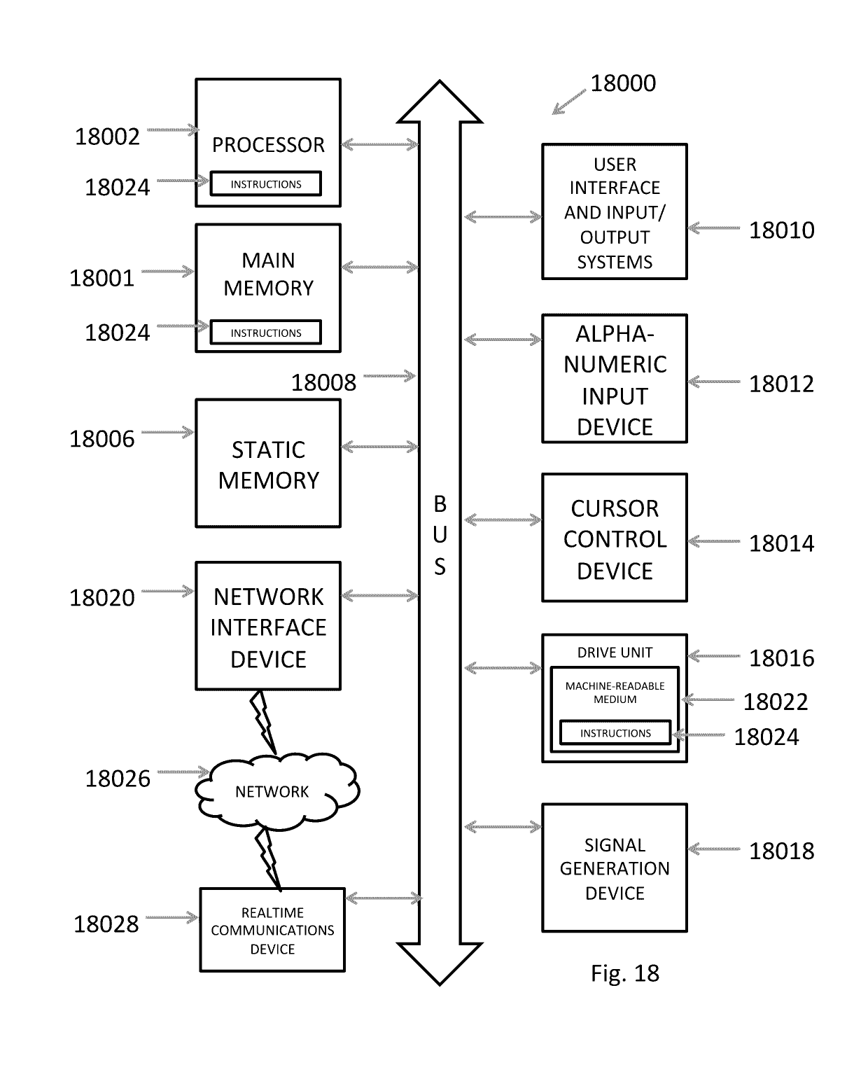

FIG. 18 shows a diagrammatic representation of a machine in the example form of a computer system 18000 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 18000 includes a processor 18002 (e.g., a Central Processing Unit (CPU), a Graphics Processing Unit (GPU) or both), a main memory 18001 and a static memory 18006, which communicate with each other via a bus 18008. The computer system 18000 may further include any user interface and input output systems 18010 (e.g. and not limited to, a Liquid Crystal Display (LCD) or a Cathode Ray Tube (CRT)). The computer system 18000 also includes an alphanumeric input device 18012 (e.g., a keyboard), a User Interface (UI) cursor controller 18014 (e.g., a mouse), a disk drive unit 18016, a signal generation device 18018 (e.g., a speaker), a network interface device 18020 (e.g., a transmitter), and a realtime communications device 18028 (e.g., a web socket).

The disk drive unit 18016 includes a machine-readable medium 18022 on which is stored one or more sets of instructions 18024 and data structures (e.g., software) embodying or used by any one or more of the methodologies or functions illustrated herein. The software may also reside, completely or at least partially, within the main memory 18001 and/or within the processor 18002 during execution thereof by the computer system 18000, the main memory 18001 and the processor 18002 also constituting machine-readable media.

The instructions 18024 may further be transmitted or received over a network 18026 via the network interface device 18020 using any one of a number of well-known transfer protocols (e.g. but not limited to, HTTP, Session Initiation Protocol (SIP)).

The instructions 18024 may further be transmitted or received over a network 18026 via the realtime communications device 18028 using any one of a number of well-known transfer protocols (e.g., Web RTC, XMPP).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

### Addtional Notes

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1. A method comprising:
retrieving from non-volatile storage a plurality of member profiles created by a plurality of members of a social networking service;
executing, on one or more computer processors, a text classification algorithm to determine which of the plurality of members possesses a signal that matches any of a plurality of provided signals and associated signal attributes; and
for at least one signal of the plurality of provided signals, identifying the plurality of members that possess the signal and ranking the plurality of members relative to one another using a ranking algorithm, the ranking algorithm being based in part upon weighted interactions among the plurality of members that possess the given signal, the weighted interactions comprising endorsements between a first member who possesses the given signal and, either a second member who possesses the given signal or a social networking service that suggests the given signal.

2. The method of claim 1, wherein the associated signal attributes includes co-ocurrent phrases.

3. The method of claim 1, wherein the text classification algorithm can be a bayes classifier and does not preclude the use of other text classification methods.

4. The method of claim 3, wherein evidence used in the text classification algorithm comprises the plurality of provided signals, associated signal attributes, and uncategorized signals.

5. The method of claim 1, further comprising:
collecting and analyzing a plurality of member behavior information.

6. The method of claim 5, wherein the weighted interactions include the plurality of member-specific and member-created source behavior data including but not limited to: skills, certifications, endorsements, accomplishments, citations, portfolio items, awards, education, test scores, degrees, licenses, professional licenses, software licenses, education classes, professional training, jobs, roles, companies, promotions, job titles, bosses, languages, achievements, hobbies, clubs, leagues, organizations, teams, societies, activities, memberships, friendships, relatives, status updates, browser history, media viewing history, conversations, contributions, collaborations, projects, lists, subscriptions, physical attributes, personality tests, meta data, phone call history, email history, events, schedules, calendars, reputation scores, sentiment, activity feeds, devices used, photos uploaded, locations visited, bookmarks saved, payments, downloads, and applications used, all of which equates to a member data set.

7. The method of claim 6, wherein a feedback loop is created that can categorize uncategorized signals using a ranking algorithm, which can be a stack ranking to find the top uncategorized signals among a group of members and adjusted based on commonalities and re-run to re-compute signal categorization.

8. The method of claim 1, wherein the endorsements comprise:
an invitation to connect sent by the first member to the second member.

9. The method of claim 1, wherein the endorsements comprise:
member profile views of the first member by the second member.

10. The method of claim 1, wherein the endorsements comprise:
inclusion of the first member by the second member in the second member's address book.

11. The method of claim 1, wherein the endorsements comprise:
the first and second members appearing in a common group on the social networking site.

12. The method of claim 1, further comprising:
calculating a score for a company for the given signal, by aggregating a rank for the given signal of any of the plurality of members who possess the given signal and who report in their profiles that they work for the company; and based on the company score, increasing or decreasing the rank for the given signal of any of the plurality of members who possess the given signal and who report in their profiles that they work for the company.

13. The method of claim 1, further comprising:
adjusting a rank of a particular member selected from the plurality of members who possess the given signal based upon connections associated with the particular member on a second social networking site.

14. The method of claim 1, wherein a weight given to a particular weighted interaction between the plurality of members who possess the given signal is based upon a rank of the members involved in the interaction.

15. The method of claim 14 further comprising:
iteratively adjusting the weights and recalculating the rankings until convergence.

16. The method of claim 1, further comprising:
calculating a score for a geographic region for the given signal by aggregating a rank for the given signal of any of the plurality of members who possess the given signal and who report in their profiles that they work in the geographic area; and based on the geographic score, increasing or decreasing the rank for the given signal of any of the plurality of members that possess the given signal and who report in their profiles that they work in the geographic region.

17. A system comprising:
a retrieval module executable on a computer processor to retrieve a plurality of member profiles created by a plurality of members of a social networking service;
a tagging module executable on one or more computer processors to run a text classification algorithm on the plurality of member profiles to determine which of the plurality of members possesses a signal that matches any of a plurality of provided signals and associated signal attributes; and
a ranking module configured to:
for at least one signal of the plurality of provided signals, identify the plurality of members that possess the signal and rank them relative to each other using a ranking algorithm, the ranking algorithm being based at least upon weighted interactions among members that posses the given signal, the weighted interactions comprising endorsements between a first member who possesses the given signal and, either a second member who possesses the given signal or a social networking service that suggests the given signal.

18. The system of claim 17, wherein the associated signal attributes includes co-occurrent phrases.

19. The system of claim 17, wherein the text classification algorithm can be a bayes classifier and does not preclude the use of other text classification methods.

20. The system of claim 19, wherein evidence used in the text classification algorithm comprises the plurality of provided signals, associated signal attributes, and uncategorized signals.

21. The system of claim 17, wherein the tagging module collects and analyzes a plurality of member behavior metrics.

22. The system of claim 21, wherein the rankings modules adjusts the ranking of the members that possess the signal based upon the plurality of member-specific and member-created source behavior metrics including but not limited to:
skills, certifications, endorsements, accomplishments, citations, portfolio items, awards, education, test scores, degrees, licenses, professional licenses, software licenses, education classes, professional training, jobs, roles, companies, promotions, job titles, bosses, languages, achievements, hobbies, clubs, leagues, organizations, teams, societies, activities, memberships, friendships, relatives, status updates, browser history, media viewing history, conversations, contributions, collaborations, projects, lists, subscriptions, physical attributes, personality tests, meta data, phone call history, email history, events, schedules, calendars, reputation scores, sentiment, activity feeds, devices used, photos uploaded, locations visited, bookmarks saved, payments, downloads, and applications used, all of which equates to a member data set.

23. The method of claim 22, wherein a feedback loop is created that can categorize uncategorized signals using a ranking algorithm, which can be a stack ranking to find the top uncategorized signals among a group of members and adjusted based on commonalities and re-run to re-compute signal categorization.

24. The system of claim 17, wherein the endorsements comprise:
an invitation to connect sent by the first member to the second member.

25. The system of claim 17, wherein the endorsements comprise:
member profile views of the first member by the second member.

26. The system of claim 17, wherein the endorsements comprise:
inclusion of the first member by the second member in the second member's address book.

27. The system of claim 17, wherein the endorsements comprise:
the first and second members appearing in a common group on the social networking site.

28. The system of claim 17, wherein the ranking module calculates a score of a company for the given signal, by aggregating a rank for the given signal of any of the plurality of members who possess the given signal and who report in their profiles that they work for the company; and based on the company score, increasing or decreasing the rank for the given signal of any of the plurality of members that possess the given signal and who report in their profiles that they work for the company.

29. The system of claim 17, wherein the ranking module adjusts a rank of a particular member selected from the plurality of members that possess the given signal based upon the number of connections associated with the particular member on a second social networking site.

30. The system of claim 17, wherein the ranking module adjusts weights given to a particular weighted interaction between the plurality of members that possess the given signal based upon a rank of the members involved in the interaction.

31. The system of claim 30, wherein the ranking module iteratively adjusts the weights and recalculates until convergence.

32. The system of claim 17, wherein the ranking algorithm calculates a score of a geographic region for the given signal, by aggregating a rank for the given signal of any of the plurality of members who possess the given signal and who report in their profiles that they work in the geographic area; and based on the geographic score, increasing or decreasing the rank for the given signal of any of the plurality of members that possess the given signal and who report in their profiles that they work in the geographic region.

33. A machine-readable storage medium including instructions, which when executed on the machine, causes the machine to: retrieve from non-volatile storage a plurality of member profiles created by a plurality of members of a social networking service; execute, a text classification algorithm to determine which of the plurality of members possesses a signal that matches any of a plurality of provided signals and associated signal attributes; and for at least one signal of the plurality of provided signals, identify the plurality of members that possess the signal and rank the plurality of members relative to one another using a ranking algorithm, the ranking algorithm being based in part upon weighted interactions among the plurality of members that possess the given signal, the weighted interactions comprising endorsements between a first member who possesses the given signal and, either a second member who possesses the given signal or a social networking service that suggests the given signal.
